(19) United States
(12) Patent Application Publication
(10) Pub. No.: US 2026/0119903 A1
(43) Pub. Date: Apr. 30, 2026

(54) METHOD FOR TRAINING OF LARGE LANGUAGE MODEL GPT-2 IN STORAGE-COMPUTE SEPARATION SCENARIOS

(71) Applicant: Shandong University, Jinan City (CN)

(72) Inventors: Chuanting ZHANG, Jinan City (CN); Wei WANG, Jinan City (CN); Jingping QIAO, Jinan City (CN); Haixia ZHANG, Jinan City (CN); Yueheng LI, Jinan City (CN); Xiaotian ZHOU, Jinan City (CN)

(73) Assignee: Shandong University, Jinan City (CN)

(21) Appl. No.: 19/432,123

(22) Filed: Dec. 24, 2025

(30) Foreign Application Priority Data
Sep. 16, 2025 (CN) 202511317506.X

(51) Int. Cl. G06N 3/098; G06N 3/0464; G06N 3/082

(52) U.S. Cl. CPC G06N 3/098; G06N 3/0464; G06N 3/082

(57) ABSTRACT

A method for training of a large language model GPT-2 in storage-compute separation scenarios is provided, belonging to the technical field of artificial intelligence and cloud computing, and comprising: establishing, by a client, a communication connection with a server; serializing data by the client and sending the serialized data to the server through a network transmission; receiving the serialized data by a data receiving thread created by a main process of the server and sending feedback; storing the data received by the server in a shared queue; establishing a multi-process distributed parallel training model in the server, and extracting data from the shared queue by each process for model training; receiving data by the data receiving thread while training to achieve parallel execution of training and receiving; continuing data transmission and training tasks until specified training epochs are completed or termination conditions are met.

### CROSS-REFERENCE TO RELATED APPLICATION

This application claims priority to Chinese Patent Application No. 202511317506.X, filed on Sep. 16, 2025, which is hereby incorporated by reference in its entirety.

### TECHNICAL FIELD

The present disclosure relates to the technical field of artificial intelligence and cloud computing, particularly to a method for training of a large language model GPT-2 in storage-compute separation scenarios.

### BACKGROUND ART

In current artificial intelligence model training, as the amount of data and model size continue to increase, the demand for storage and compute resources is sharply rising. The traditional storage-compute integration architecture binds compute and storage resources to a single node, which faces problems such as low resource utilization and poor scalability, resulting in inflexible resource allocation. For example, when compute-intensive tasks consume a large amount of CPU (Central Processing Unit) or GPU (Graphics Processing Unit), storage resources may be idle, and vice versa. Increasing the hardware resources of nodes can only synchronously enhance compute and storage capabilities, and cannot expand a specific resource type alone, and hardware upgrades are costly and inefficient.

Under the storage-compute integration architecture, compute and storage resources cannot be dynamically scheduled according to actual loads, resulting in low overall performance. In addition, in distributed training scenarios, multiple nodes need to frequently access the same storage resource, increasing access latency for storage and causing network bandwidth to become a performance bottleneck. In the storage-compute integration architecture, compute and storage resources are tightly coupled to a single node. Once the node fails, such as hardware damage or network connection interruption, not only will the compute task immediately stop, but the storage function will also be completely lost, resulting in the inability to access data.

The storage-compute separation architecture improves the resource utilization and scalability of the system by decoupling the compute and storage modules. After the separation of compute nodes and storage nodes, the storage-compute separation architecture can expand compute resources or storage resources separately according to actual needs, avoiding waste caused by resource coupling in traditional architectures. The storage-compute separation architecture allows for the independent addition of compute nodes or storage nodes, enabling system scalability at a lower cost and supporting larger-scale deep learning training tasks. The storage-compute separation architecture can deploy storage and compute resources across multiple geographic locations, making it particularly suitable for cloud-based deep learning tasks that require distributed storage and compute. Due to the separation of storage and compute, when a compute node fails, the storage node can maintain data integrity, and the system will not crash due to a single node failure.

The storage-compute separation architecture provides more flexible resource scheduling and higher resource utilization by decoupling compute and storage modules. In traditional storage-computer integration architectures, compute and storage requirements are often not synchronized. For example, high-compute-intensive tasks may require powerful compute power, while data storage requirements are relatively low. The data-intensive tasks require large-capacity storage resources, but the utilization of compute resources is low. This imbalance makes it difficult to optimize resource allocation, with some resources being overutilized while other resources are idle and wasted. Therefore, how to meet the different storage and compute requirements is still an urgent technical problem to be solved.

### SUMMARY

The purpose of the present disclosure is to provide a method for training of a large language model GPT-2 in storage-compute separation scenarios, which decouples storage and compute, establishes a communication connection between a client and a server using TCP/IP, and uses a desktop host as the client to store and send data, while a remote compute resource acts as the server to undertake compute tasks, solving the problem that the storage-compute integration mode cannot meet the different storage and compute requirements.

In order to achieve above objective, the present disclosure provides a method for training of a large language model GPT-2 in storage-compute separation scenarios, including:
step S1: establishing, by a client, a communication connection with a server and sending description information of a data to the server; the description information includes: a number of training epochs, a number of training batches, and a number of testing batches;
step S2: serializing the data by the client and sending the serialized data to the server through a network transmission; the serialized data includes: first four bytes representing a length of the data, and subsequent actual training data;
step S3: receiving the serialized data by a data receiving thread in a main process of the server, parsing the first four bytes to determine a length of a data blocks of the data, and storing the data in a shared queue;
step S4: training a model by the server through multiple training processes, extracting, by each of the multiple training processes, the data blocks from the shared queue, performing a word-segmentation operation, and performing a parallel training of a GPT-2 model;
step S5: repeating steps S2 to S4 until preset training-end conditions are met; and step S6: evaluating a performance of the trained GPT-2 model.

In some embodiments, in step S1, before the client sends the data to the server, communication ports of the client and the server are determined, the communication connection is established, and a size of training batch and a training dataset are selected, which include:
step S11: selection of a port number: when the communication connection is established between the client and the server, an idle port of the client and an idle port of the server are selected for establishing the communication connection and transmitting the data; and port numbers reserved by a system and port numbers already occupied by applications are not selected;
step S12: establishment of the communication connection: the client uses a temporary port allocated by an operating system to establish the communication connection with a designated port of the server; and
step S13: the size of training batch is selected based on hardware configurations of a compute resource of the server.

In some embodiments, in step S2, after the communication connection is established between the client and the server, the data is serialized, and a description information of training epoch is sent, which include:
step S21: serialization of the data: the data is serialized into a byte stream, and a byte stream data is sent; and
step S22: sending of the description information of training epoch: an information of batch size of a training dataset and a test dataset is calculated based on a number of entries and a batch size in a dataset; and before the dataset is sent, the number of training epochs, and a batch size contained in the training dataset and a batch size contained in the testing dataset in one training epoch are sent.

In some embodiments, in step S3, the data receiving thread of the server performs tasks of data reception, deserialization, and storage in the shared queue, which include:
step S31: the server parses a length information of the data from the first four bytes of the received data, and receives the data in blocks and concatenates the data blocks into a byte array;
step S32: a deserialization is performed on the byte-stream data to obtain a deserialized data; and
step S33: the deserialized data is evenly divided according to a number of the multiple training processes to obtain divided data, and the divided data is stored in the shared queue for each of the multiple training processes to access.

In some embodiments, in step S4, before the model is trained, the server also establishes communication connections, selects a model, creates the data receiving thread and the multiple training processes, which include:
step S41: establishment of communication connections: the server listens for communication connection requests on specified ports, and establishes communication connections with the client;
step S42: a multi-process distributed parallel training model GPT-2 is established based on a generative pre-trained transformer model; the GPT-2 includes: one word-position embedding layer, one word embedding layer, twelve repeatedly stacked GPT blocks, and one layer-normalization layer; and each of the twelve repeatedly stacked GPT blocks includes: two layer-normalization layers, one attention layer, and one multi-layer perceptron, with a hidden layer dimension of 768;
step S43: creation of the multiple training processes: a training model in the server adopts a distributed training approach to create multiple training processes, and controls multiple graphics-card devices to perform a same training task through the multiple training processes; after the multiple training processes are completed, model parameters are simultaneously updated; and
step S44: creation of the data receiving thread: the data receiving thread is created in the main process of the server.

In some embodiments, in step S43, the model is trained by the multiple training processes in the server, which includes: extraction of the data from the shared queue, segmenting, training of the model, back propagating, aggregation of gradients, and updating of parameters, which include:
step S431: each of the multiple training processes extracts the data from the shared queue, determines whether a data is stored in the shared queue, and blocks and waits until a data is stored in the shared queue when the shared queue is empty;
step S432: a tokenizer is used to convert continuous data into a series of subunit tokens;
step S433: training of the model: gradients of parameters are reset to zero before training, a sliding window mechanism is used to construct a source input and a target output, the source input is mapped to a word embedding representation through the word embedding layer, and an element-sum operation is performed on the word embedding representation and a word-position embedding representation to obtain an element-sum result, which is served as an input of the model; a forward propagation is performed on the input of the model and an output of the model is output; the output of the model is input into a language-header layer to convert the word embedding representation to a token representation, and a cross entropy loss between the output of the model and the target output is calculated;
step S434: the gradients are calculated through back propagation to obtain a gradient result, and the gradient result is temporarily stored in a grad attribute of model parameters;
step S435: aggregation of the gradients: an average aggregation strategy is used to aggregate gradient results obtained from the multiple training processes to obtain an aggregated result, and the aggregated result is distributed to each of the multiple training processes; and
step S436: an adaptive moment estimation optimizer AdamW with separated weight decay is used to update the model parameters.

In some embodiments, in order to make the large language model GPT-2 more effective in processing time series data, the internal architecture of the GPT-2 is improved, which includes:
one spatiotemporal embedding layer is added, and base-station-ID embedding and multi-scale temporal embedding are added on a basis of word embedding and position embedding in the GPT-2;
the attention layer of the GPT-2 is improved to one dual-stream attention layer, which includes: temporal attention sublayers and spatial attention sublayers, which are dynamically fused through a gating mechanism; and
one graph convolutional layer is added after the dual-stream attention layer to capture a topology information of a base station.

In some embodiments, in step S6, after the training of the model is completed, an effect of the model having the storage-compute separation architecture is evaluated, which includes:
step S61: for a single batch of data, a timestamp is recorded at an end of training of each batch, and adjacent two timestamps are subtracted to obtain a training time for one batch;
step S62: time for forward propagation, back propagation, and gradient update of each batch of data is recorded as a compute time, and a difference between a training time and a compute time of a data batch is recorded as a communication time; and
step S63: a training time, a communication time, and a compute time of each batch in scenarios of storage-compute separation and storage-compute integration are recorded, and the training time, the communication time, and the compute time of all batches are compared and a comparison graph is drawn.

Therefore, the present disclosure proposes a method for training of a large language model GPT-2 in storage-compute separation scenarios, which has following beneficial effects:
(1) The method for training of the model in storage-compute separation scenarios proposed by the present disclosure breaks the binding of compute and storage on a single node, enabling flexible and dynamic scheduling of compute and storage resources based on actual loads.
(2) The present disclosure achieves efficient data transmission and computation by storing data in the client and computing in the server, supporting tasks such as training of large-scale deep learning model.
(3) The present disclosure utilizes independent receiving threads and shared queues to achieve data reception, deserialization, and parallel model training. And the present disclosure partially overlaps network communication time with compute time, effectively masking network latency and reducing the impact of communication overhead on overall training speed.
(4) Targeted improvements are made to the general GPT model, introducing the spatiotemporal embedding layer, the dual-stream attention layer, and the graph convolutional layer to better capture spatiotemporal dependencies in time series data and enhance the performance of the model in tasks such as cellular traffic prediction.

### BRIEF DESCRIPTION OF THE DRAWINGS

FIG. 1 shows a flowchart of the method for training of a large language model GPT-2 in storage-compute separation scenarios.

FIG. 2 shows a schematic structural diagram of the method for training of the large language model GPT-2 in storage-compute separation scenarios.

FIG. 3 shows a schematic diagram of the improved architecture of GPT-2.

FIG. 4 shows a result comparison graph between the training time of each batch in the storage-compute separation scenario and the training time of each batch in the storage-compute integration scenario.

### DETAILED DESCRIPTION OF THE EMBODIMENTS

The following provides further explanation of the technical solution of the present disclosure through the accompanying drawings and embodiments.

Unless otherwise defined, the technical or scientific terms used in the present disclosure shall have the usual meanings as understood by those skilled in the art to which the present disclosure belongs.

### EMBODIMENTS

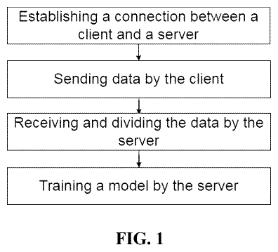

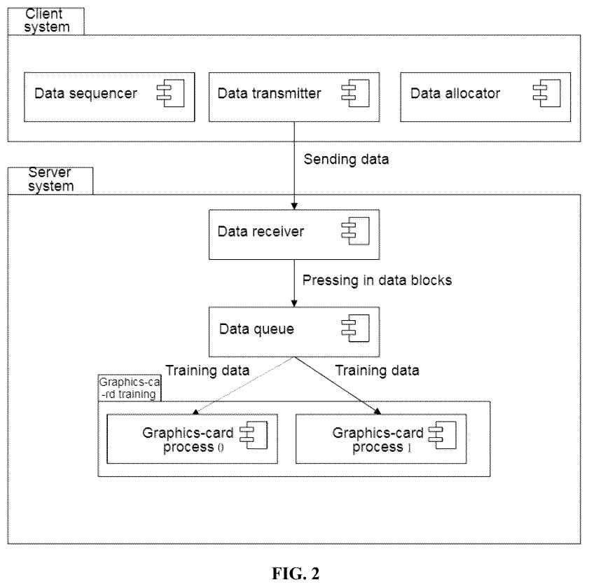

As shown in FIGS. 1 and 2, the present disclosure provides a method for training of a large language model GPT-2 in storage-compute separation scenarios. The method is implemented based on a client system and a server system. The client in the client system is responsible for storing and sending data, while the server is responsible for compute tasks. The method includes following specific steps S1 to S6.

Specific steps of the client in the storage-compute separation scenario are as follows:
In step S1, the client finely divides the large training data into independent data blocks and generates a unique index for each data block for quick location and retrieval.
In step S2, the client establishes a communication connection with the server, which includes following specific steps S21 to S23.
In step S21, the appropriate port number is selected. When the communication connection between the client and the server is established, both the client and the server need to choose idle ports for establishing the connection and transmitting data. It is important to note that system reserved port numbers and port numbers already occupied by applications should not be selected to ensure that the communication connection is established correctly.
In step S22, the client establishes the communication connection with the designated port of the server using the temporary port allocated by the operating system.
In step S23, the batch size is selected based on the hardware configuration of the server's compute resources. Batch size will affect the graphics card's memory usage during model training. Too large batch size can lead to insufficient memory.
In step S3, the client sends detailed data description information to the server, including the number of training epochs, and send number of training-data batches and send number of testing-data batches of each training epoch.

In order to enable the server to know the batch-size description information of the training dataset and the testing dataset, the batch-size information of the training dataset and the testing dataset is first calculated based on the number of entries and batch size in the dataset. Before the dataset is sent, the number of training epochs and the number of batches contained in each training dataset and each testing dataset in one training epoch are first sent.

In step S4, the client serializes the data, setting the first four bytes as information representing the length of the data according to the design, and the subsequent bytes as training data. The dataset contains wireless cellular traffic values of about 150 base stations in a certain location, with a time range from Jul. 28, 2024 to Aug. 25, 2024, and a data collection interval of 15 minutes. The wireless cellular traffic data is serialized into byte streams to help preserve complex data structures and quickly send the data structures to the server.

In step S5, the client uses TCP/IP communication protocol to quickly send the serialized data to the server.

In step S6, the client blocks and waits for the server to receive feedback information indicating that reception of the serialized data is completed.

In step S7, steps S4 to S6 are repeated until the preset training-end conditions are met.

The specific steps of the server in storage-compute separation scenario include following steps T1 to T9:

In step T1, the server utilizes a multi-process architecture, with each process controlling one GPU device separately.

In step T2, the main process of the server creates a dedicated data receiving thread responsible for receiving data sent by the client. After receiving the serialized data, the data receiving thread first parses the first four bytes to accurately obtain the length information of the training data, then fully obtains the actual training data through a loop receiving method. The specific steps include following steps T21 to T22:

In step T21, the server first parses the length information of the training data from the first four bytes of the received data, and then receives the data in blocks and concatenates the data blocks into a byte array.

In step T22, the received byte-stream data is deserialized into wireless cellular traffic data.

In step T3, the data receiving thread of the server further divides the received data into multiple sub blocks and stores them in an orderly manner in the shared queue. Specifically, the received sequence data is evenly divided according to the number of training processes, so that each process can process approximately the same amount of sequence data, and the divided data is stored in the shared queue for the training process to access.

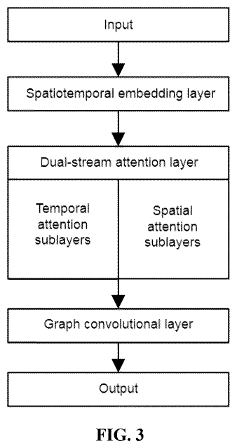

In step T4, the server initializes the large language model GPT-2. In order to make the GPT-2 more effective in processing time series data, the spatiotemporal embedding layer, the dual-stream attention layer, and the graph convolutional layer are designed to improve the GPT-2. The improved model architecture is shown in FIG. 3. The spatiotemporal embedding layer adds base station ID (Identity Document) embedding and multi-scale time embedding to the word embedding and position embedding inherent in the GPT-2. The dual-stream attention layer splits the attention layers contained in each Transformer block into temporal attention sublayers and spatial attention sublayers, and dynamically fuses the attention sub layers and the spatial attention sub layers through a gating mechanism. The graph convolution enhancement layer adds a graph convolutional network layer after the attention layer to capture the topological structure information of the base station and improve the modeling ability of spatial propagation patterns.

In step T5, the training process extracts data blocks from the queue in order for spatiotemporal aware forward propagation. Multi-modal feature fusion is performed through the spatiotemporal embedding layer to uniformly encode heterogeneous input information into the same feature space. Different types of information such as numerical traffic data, discrete base-station identifiers, and periodic time information are fused. The embedding layer learns the optimal representation for each dimension, providing semantically rich input vectors for subsequent attention calculations.

In step T6, the heterogeneous information is uniformly encoded through the spatiotemporal embedding layer, the temporal and spatial correlations of wireless cellular traffic are modeled through the dual-stream attention layer, traffic patterns are captured through temporal attention sublayers, traffic correlations in functionally similar areas are identified through spatial attention sublayers, and two attention streams are dynamically weight fused through a gating mechanism.

In step T7, the topology information of the base station network is strengthened through the graph convolutional layer, graph convolution is applied on the output of the attention layers for reinforcing spatial features to supply the local spatial structure information that the attention mechanism may overlook, and improve the modeling ability of spatial propagation patterns.

In step T8, the feedforward neural network retains the original structure of GPT-2 and uses fully connected networks and the GELU (Gaussian Error Linear Units) activation function to inherit the powerful representation ability of the pre-trained model.

In step T9, steps T5 and T8 are repeated until the training-end conditions are met.

After the model training is completed, it is necessary to evaluate the effect of the model with storage-compute separation architecture, which includes following steps W1 to W3:

In step W1, for a single data batch, the timestamp is recorded at the end of training in each batch, and adjacent two timestamps are subtracted to obtain the training time for one batch.

In step W2, the time for forward propagation, back propagation, and gradient update of each data batch is recorded as the compute time, and the difference between the training time and compute time of a data batch is recorded as the communication time.

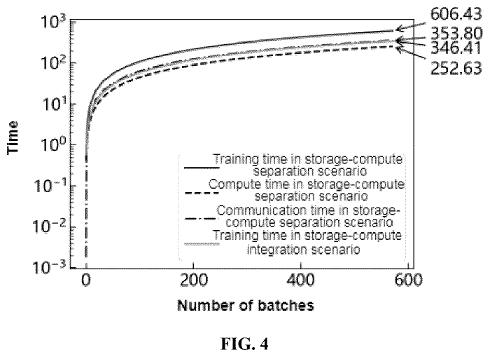

In step W3, the training time, the communication time, and the compute time of each batch in the scenarios of storage-compute separation and storage-compute integration are recorded, and they are compared and the comparison results are showed in FIG. 4.

It is worth noting that the contents not elaborated in detail in the present disclosure are all prior art and are well-known to those skilled in the art.

Therefore, the present disclosure provides the method for training of the large language model GPT-2 in storage-compute separation scenarios, in which the physical separation of data storage and model training is achieved through the client-server architecture. The client is responsible for data serialization and transmission, while the server is responsible for data reception, deserialization, and multi-process distributed training. This method supports parallel execution of data reception and training processes, enhances the modeling ability of spatiotemporal sequence data using the improved GPT-2 model, and improves training efficiency and system resource utilization.

Finally, it should be noted that the above embodiments are only used to illustrate the technical solution of the present disclosure and not to limit it. Although the present disclosure has been described in detail with reference to the preferred embodiments, those skilled in the art should understand that modifications or equivalent substitutions can still be made to the technical solution of the present disclosure, and these modifications or equivalent substitutions cannot make the modified technical solution deviate from the spirit and scope of the technical solution of the present disclosure.

What is claimed is:

1. A method for training of a large language model GPT-2 in storage-compute separation scenarios, based on a client system and a server system, wherein a communication connection is established between a client of the client system and a server of the server system using TCP/IP, with a desktop host serving as the client to store and send data, and a remote compute resource serving as the server to undertake compute tasks; wherein the method comprises:
step S1: establishing, by the client, the communication connection with the server and sending description information of a data to the server; wherein the description information comprises: a number of training epochs, a number of training batches, and a number of testing batches;
step S2: serializing the data by the client and sending the serialized data to the server through a network transmission; wherein the serialized data comprises: a first four bytes representing a length of the data, and subsequent actual training data;
step S3: receiving the serialized data by a data receiving thread in a main process of the server, parsing the first four bytes to determine the length of the data, and storing the data in a shared queue;
step S4: training a model by the server through a plurality of training processes, extracting, by each of the plurality of training processes, data blocks of the data from the shared queue, performing a word-segmentation operation, and performing a parallel training of a GPT-2 model;
step S5: repeating steps S2 to S4 until preset training-end conditions are met; and
step S6: evaluating a performance of the trained GPT-2 model;
wherein in step S4, before the parallel training of the GPT-2 model is performed, the server also establishes communication connections, selects a model, and creates the data receiving thread and the plurality of training processes, by:
step S41: establishing communication connections, wherein the server listens for communication connection requests on specified ports, and establishes communication connections with the client;
step S42: establishing a multi-process distributed parallel training model GPT-2 based on a generative pre-trained transformer model; wherein the GPT-2 comprises: one word-position embedding layer, one word embedding layer, twelve repeatedly stacked GPT blocks, and one layer-normalization layer; and wherein each of the twelve repeatedly stacked GPT blocks comprises: two layer-normalization layers, one attention layer, and one multi-layer perceptron, with a hidden layer dimension of 768;
step S43: creating the plurality of training processes, wherein a training model in the server adopts a distributed training approach to create a plurality of processes to control a plurality of graphics-card devices to perform a same training task; and wherein after the plurality of processes is completed, model parameters are simultaneously updated; and
step S44: creating the data receiving thread, wherein the data receiving thread is created in the main process of the server;
and wherein an internal architecture of the GPT-2 is improved, by:
adding a spatiotemporal embedding layer is, and adding base-station-ID embedding and multi-scale temporal embedding on a basis of word embedding and position embedding in the GPT-2;
converting the attention layer of the GPT-2 to a dual-stream attention layer, which comprises temporal attention sublayers and spatial attention sublayers, which are dynamically fused through a gating mechanism; and
adding one graph convolutional layer after the dual-stream attention layer to capture a topology information of a base station.

2. The method for training of the large language model GPT-2 in storage-compute separation scenarios according to claim 1, wherein in step S1, before the client sends the data to the server, communication ports of the client and the server are determined, the communication connection is established, and a size of training batch and a training dataset are selected, by:
step S11: selecting a port number: when the communication connection is established, an idle port of the client and an idle port of the server are selected for establishing the communication connection and transmitting the data; and port numbers reserved by a system and port numbers already occupied by applications are not selected;
step S12: establishing the communication connection: the client uses a temporary port allocated by an operating system to establish the communication connection with a designated port of the server; and
step S13: selecting the size of the training batch based on hardware configurations of a compute resource of the server.

3. The method for training of the large language model GPT-2 in storage-compute separation scenarios according to claim 1, wherein in step S2, after the communication connection is established between the client and the server, the data is serialized, and a description information of training epoch is sent, bv:
step S21: serializing the data, wherein the data is serialized into a byte stream, and a byte-stream data is sent; and
step S22: sending the description information of training epoch, wherein an information of batch size of a training dataset and a test dataset is calculated based on a number of entries and a batch size in a dataset; and before the dataset is sent, the number of training epochs, and a batch size contained in the training dataset and a batch size contained in the testing dataset in one training epoch are sent.

4. The method for training of the large language model GPT-2 in storage-compute separation scenarios according to claim 1, wherein in step S3, the data receiving thread of the server performs tasks of data reception, deserialization, and storage in the shared queue, by:
step S31: parsing a length information of the data from the first four bytes of the received data on the server, and receiving the data in blocks and concatenating the data in the blocks into a byte array;
step S32: deserializing byte-stream data to obtain a deserialized data; and
step S33: dividing the deserialized data according to a number of the plurality of training processes to obtain divided data, wherein the divided data is stored in the shared queue for each of the plurality of training processes to access.

5. The method for training of the large language model GPT-2 in storage-compute separation scenarios according to claim 1, wherein in step S43, the training model in the server is configured for extracting the data from the shared queue, segmenting, training the model, back propagating, aggregating gradients, and updating parameters, by:
step S431: extracting the data from the shared queue, determining whether a data is stored in the shared queue, and blocking and waiting until a data is stored in the shared queue when the shared queue is empty in each of the plurality of training processes;
step S432: converting continuous data into a series of subunit tokens with a tokenizer;
step S433: training the model, wherein gradients of parameters are reset to zero before training, a sliding window mechanism is used to construct a source input and a target output, the source input is mapped to a word embedding representation through the word embedding layer, and an element-sum operation is performed on the word embedding representation and a word-position embedding representation to obtain an element-sum result, which is served as an input of the model; a forward propagation is performed on the input of the model and an output of the model is output; the output of the model is input into a language-header layer to convert the word embedding representation to a token representation, and a cross entropy loss of the output of the model and the target output is calculated;
step S434: calculating the gradients through back propagation to obtain a gradient result, wherein the gradient result is temporarily stored in a grad attribute of model parameters;
step S435: aggregating the gradients, wherein an average aggregation strategy is used to aggregate gradient results obtained from the plurality of training processes to obtain an aggregated result, and the aggregated result is distributed to each of the plurality of training processes; and
step S436: updating the model parameters with an adaptive moment estimation optimizer AdamW with separated weight decay.

6. The method for training of the large language model GPT-2 in storage-compute separation scenarios according to claim 1, wherein in step S6, after the training of the model is completed, an effect of the model having the storage-compute separation architecture is evaluated, by:
step S61: recording, for a single data batch, a timestamp at an end of training of the batch, wherein an adjacent two timestamps are subtracted to obtain a training time for the batch;
step S62: recording time for forward propagation, back propagation, and gradient update of each data batch as a compute time, wherein a difference between a training time and a compute time of a data batch is recorded as a communication time; and
step S63: recording a training time, a communication time, and a compute time of each batch in scenarios of storage-compute separation and storage-compute integration, wherein the training time, the communication time, and the compute time of all batches are compared and a comparison graph is drawn.
